(19) United States
(12) Patent Application Publication
(10) Pub. No.: US 2017/0003035 A1
(43) Pub. Date: Jan. 5, 2017

(54) RETAINER PANEL FOR A PANEL HEATING SYSTEM

(71) Applicant: Wischemann Kunststoff GmbH, Ochtrup (DE)

(72) Inventors: Ingo Wischemann, Ochtrup (DE); Stefan Hubert Ossendorf, Ochtrup (DE)

(21) Appl. No.: 15/267,162

(22) Filed: Sep. 16, 2016

Related U.S. Application Data
(63) Continuation of application No. PCT/EP2015/053217, filed on Feb. 16, 2015.

(30) Foreign Application Priority Data
Mar. 20, 2014 (DE) 20 2014 101 286.9

(51) Int. Cl. F24D 3/14; F16L 3/26

(52) U.S. Cl. CPC F24D 3/142; F16L 3/26; F24D 2220/0292

(57) ABSTRACT

Retainer panel of a panel heating system. The retainer panel has a carrier to which a structural surface is directly laminated. The structural surface is serves as one component of a touch hook-and-loop fastener. The carrier has a relief surface with a configuration of raised and relief areas that forms a grid of channels. The channels are dimensioned to accommodate the layout of a heating tube. The heating tube carries the second component of the touch hook-and-loop fastener that interacts with the first component to hold the heating tube in-place on the retainer panel.

### BACKGROUND INFORMATION

Field of the Invention

The invention relates to the field of panel heating systems and, more particularly, to a retainer panel that holds heating tubes in place on the panel.

Discussion of Prior Art

Panel heating systems are frequently used to heat large surface areas, for example, under-floor heating systems, or systems for heating a wall or a ceiling. A fluid that carries the heat medium flows through flexible tubes or pipes, which are laid out on the panel with a certain desired geometry that will achieve an even heating of the large surface. Multiple panels are laid out as needed to cover the surface, whereby the panels are arranged so to that the heating tube, which is typically laid out in a serpentine path, can extend across several panels. These panel systems, as mentioned, are frequently used for heating purposes, but it is also possible, that they can be used for cooling purposes, in which case, a suitable coolant flows through the tubes. For the sake of brevity, the system hereinafter will simply be referred to as a panel heating system having retainer panels and heating tubes, but it is understood, that the discussion is not limited to heating systems, but also includes cooling systems.

Retainer panels for such panel heating systems typically have a substrate or carrier and then some form of a structural surface on the top surface of the carrier that is designed to hold the heating tube in place on the panel. An example of one type of retainer panel is a nipple or stud plate, which has undercut protrusions that extend upward, that two adjacent nipples or studs are dimensioned to accommodate the diameter of the tube. In other words, the tube snaps into the undercut area and is located on the panel in this way. Some of these types of plates don't have the undercuts, but instead, have nubs that taper toward the top. With both types of retainer panels, the intent is always to place a steel plate on the protrusions and to adhesively affix or screw the plate to them.

Some retainer panels that are used as floor heating tiles have a smooth upper side, without any guide or fastening means for the heating tubes. Rather, the heating tubes are fixed in location by means of mechanical holders that are anchored in the floor heating tiles.

Some retainer panels use a structural surface on a carrier to hold the heating tube in place. One type has a nubbed film, the nubs serving to clamp the tube in place. An insulating panel is placed beneath the nubbed film and connected to the film. The use of a touch hook-and-loop fastener is suggested as a possible connector means.

European publication EP 1 645 700 A1 discloses a heatable floor structure, which uses a heating panel that carries a heating tube. The heating panel has grooves for receiving and fixing the placement of the heating tube. A touch hook-and-loop fastener is used to releasably fix the heating panel on a heavy mat that is placed on an existing floor without a fastening means. Thus, the heating panel may be pulled from the heavy mat without damage, and the heavy mat then be removed from the floor without leaving a trace.

German publication DE 20 2010 011 520 U1 discloses a retainer panel that has a structural surface on the front or top side of a carrier, whereby the structural surface serves to fasten the heating tubes by means of a fastener. The carrier defines the basic shape of the panel, for example, rectangular, square, hexagonal, etc., and has a material thickness that ranges from 1 to 2 mm up to several centimeters. The carrier also determines mechanical properties of the retainer panel, for example, whether it is soft or hard, deformable or rigid. Only a small portion of the circumference, i.e., the wall, of the heating tube contacts the structural surface on this retainer panel, because the panel essentially has a flat surface without topographical contours, and just the very lowest portion of the tube makes contact with the structural surface. The bottom or rear side of the retainer panel is placed on a substrate or fastened to sub-flooring.

The structural surface on this retainer panel actually forms one half of a fastener means. The carrier is a film, and the structural surface is adhesively affixed across the entire top surface of the carrier. This structural surface is the fleece component, i.e., the loop component, of a touch hook-and-loop fastener. This type of film is known in the industry and is typically referred to as a fleece film.

Such fleece films are conventionally placed on a rigid panel of expanded polystyrene (EPS), so that this type of retainer panel is a composite construction of three layers: the EPS panel, the carrier film, and the structural surface. The retainer panel serves not only to hold the heating tubes, for example, for an under-floor, wall, or ceiling heating system, but the EPS panel of the conventional retainer panel also provides thermal insulation against the substrate on which the retainer panel is placed.

When laying heating tubes with this state of the art, the heating tubes are provided with a structural surface that meshes or interacts with the structural surface of the retainer panel. Thus, in the case where the structural surface on the retainer panel is a fleece component of a touch hook-and-loop fastener, the hook component is applied to the tube. Pressing the heating tube onto the retainer panel fixes the heating tube in place, due to the meshing of the hook and loop components.

A touch hook-and-loop fastener represents in the industry one suitable type of a releasable fastener, whereby other types of fasteners can be used, particularly those that allow a correction in the layout of the tubes. For reasons of brevity, the releasable fastener that is used to fix the heating tube on the retainer panel is referred to in the following discussion as a touch hook-and-loop fastener, but it is understood that other suitable, releasable fasteners may be used. For example, the two structured surfaces of the heating tube and the retainer panel may be constructed identically and each have a plurality of mushroom-like button elements that can be pressed or snapped into each other, but can also be pulled apart again.

The fleece component with the loops is less expensive to manufacture than the hook component, and for this reason, a fleece film is typically used as the structural surface on the retainer panel, which has to cover a relatively large area. The more expensive hook component is then provided on the heating tube. Typically this hook component is not provided as a complete sheath around the tube, but rather, as tape or band that is wound on the tube in a spiral-form, so that only a substantially smaller surface area has to be covered with this more expensive material to adequately fasten the heating tube to the retainer panel. But other considerations may make it desirable to do the opposite, i.e., provide the hook component as the structural surface on the retainer panel and the loop component on the tube.

What is needed, therefore, is a retainer panel that is inexpensive to produce, has a very low overall thickness, and releasably affixes a heating tube to the panel. What is further needed is such a panel that is easily laid out with adjacent panels and that simplifies the layout of the heating tube.

### BRIEF SUMMARY OF THE INVENTION

It is an object of the invention, to improve a conventional retainer panel for a panel heating system such, that the construction of the panel beneath the heating tubes is as inexpensive as possible to produce. Further, it is an object of the invention to provide a retainer panel that has the flattest profile or thickness possible, as a means to reduce the height of the panel system. It is also an object of the invention to provide a simple means of laying out and reliably fixing the heating tube in place on the retainer panel.

The term “heating tube” used hereinafter refers generally to a conductor of a heat-conducting medium. This heating tube may be a conventional pipe or tube through which a fluid medium flows, but the term also includes conductors in an electrical panel heating system. The electrical conductor is similar to the heating tube to the extent that it has a tube-like insulating sheath that surrounds the conducting medium, in this case, a wire conductor. The term “panel heating system” is representative of installations that use the retainer panel according to the invention, and particularly, panels with heating tubes fixed in place on them. Such installations are much more frequently used as heating systems, but they may also be used as cooling systems. The heat-conducting medium in the latter case would be a coolant. It is understood, therefore, that the term “panel heating” used hereinafter encompasses panel systems for regulating the temperature of a surface, be it for heating or cooling.

The retainer panel according to the invention has a carrier and a structural surface formed or placed on top of the carrier. The carrier is made of a material that is plastically deformable when being produced and has raised areas on it that form a relief structure. The structural surface is, for example, a fleece film that is directly laminated onto the carrier and serves as the fleece or velour component of a touch hook-and-loop fastener. The material of this structural surface may be pressed onto the carrier by means of a pressing tool, for example, a roller, while the carrier is being produced. In other words, the carrier does not have to be produced separately, cured, and then at a later time, perhaps hours or even days later, the structural surface be laminated to it. Rather, the structural surface may be directly laminated onto the plastically deformable carrier before the carrier is cured. The material of the structural surface is pressed partially into the material of the carrier during lamination. This direct lamination results in a firm bond between the structural surface and the carrier, which is created as the carrier cures.

This method of directly laminating the structural surface onto the carrier has several advantages. First, the structural surface is bonded to the carrier without the use of additional material, such as an adhesive. Thus, the direct lamination eliminates the need of an intermediate product that is the fleece film plus an adhesive layer. This reduces the cost of producing the retainer panel according to the invention, because it eliminates material and work steps. The direct lamination also makes it possible to create a retainer panel that is significantly flatter in overall height, i.e., thinner, than conventional retainer panels. The conventional retainer panel that uses a structural surface to fix the heating tube in place is first coated with an adhesive. This so created adhesive retainer panel is then adhesively affixed to an additional carrier, for example, to a rigid panel, so that, by comparison, the conventional retainer panel is requires more space, i.e., is thicker, requires more material, and entails more work steps.

A further advantage of the direct lamination process is that several material handling steps may be eliminated, such as, for example, placing the carrier in intermediate storage and re-heating the carrier to make it plastically deformable again. The direct lamination also eliminates the energy input that would be required to re-heat the carrier.

Alternatively, if the carrier is made of a thermoplastic material, then an already produced carrier need only be heated to obtain the desired plastic deformability for laminating the structural surface to the carrier.

It is important that the plurality of retainer panels that form the panel heating system be laid out in an evenly spaced grid to achieve the desired thermal performance and even distribution of heat. To this end, it is desirable that sections of the heating tube that are placed across the plurality of retainer panels are evenly spaced. The conventional practice is to print some kind of layout grid on the retainer panel that serves as a guide for the layout of the heating tube. Thus, for example, lines, dots, or other graphical elements are printed on the conventional panel with the desired layout grid.

The relief structure of the carrier serves not only to hold the heating tube in place on the retainer panel, but also as a layout grid. The relief structure provides easy optical recognition of a layout grid, without any additional printing. This relief structure thus eliminates material and process steps that would otherwise be necessary for creating the layout grid, for example, printing a colored grid onto the retainer panel.

The three-dimensional relief structure on the top or front side of the carrier, i.e., the side in contact with the structural surface, serves to significantly increase the holding forces that are exerted on the heating tubes than is possible with a retainer panel having a flat structure. The relief structure provides raised areas that delineate relief or deeper areas. The heating tubes are laid out in the relief or deeper areas of the retainer panel, such that portions of the tube wall are in contact with the raised areas of the structural surface. As a result, the area of contact of the heating tube with the retainer panel is significantly greater than is the case when only the lowest portion of the tube wall makes a line-like narrow band of contact with a retainer panel, which is the case when the layout surface of the retainer panel is flat. But, even if the heating tube does not have contact with the sides of raised areas, the area of contact between the heating tube and the retainer panel is still greater than that of a conventional retainer panel, because just providing a structural surface that includes a trough or channel provides a greater contact of the circumference of tube wall with the structural surface than the narrow line-like contact that results when a round tube is placed on a flat surface.

In a first embodiment of the retainer panel according to the invention, two parallel ribs form a channel on the carrier that is dimensioned to accommodate a portion of the circumference of the heating tube that is to be placed in the channel. As mentioned above, the structural surface provides the fleece component and the heating tube the hook component of a touch hook-and-loop fastener. The channel increases the effective contact surface between the hook component and the fleece component, and this increases the pull forces that are necessary to move or remove the heating tube, thereby increasing the reliable hold of the heating tube on the retainer panel.

The retainer panel may also be constructed, so as to readily deform to the geometry of the heating tube when the tube is pressed onto the retainer panel. To this end, the structural surface may be firmly bonded with the carrier in certain areas only, namely, bonded only to the raised areas on the carrier. For example, the structural surface may be pressed onto the carrier during the laminating process by means of a roller and, depending on the size of the roller and the relief structure of the carrier, the material of the structural surface makes direct contact only at raised areas of the carrier. Between the raised areas, then, areas of the structural surface extend across or hang down slightly in the deeper areas of the carrier. As a result, this structural surface is relatively freely movable at these deeper areas and therefore readily adaptable to a portion of the circumference of the tube that is pressed onto the retainer panel.

The same advantage may also be achieved with a different relief structure of the carrier, for example, with raised profiles that are constructed in the form of identically sized or differently sized nubs or nipples, or in the form of a cross. The distances between each of these raised profiles form troughs that function similarly to the channels that are formed between two parallel ribs and that are able to accommodate a portion of the circumference of a tube. The discussion below frequently refers to ribs and channels, whereby these are only representative for the formation of lower and raised areas of the retainer panel, including these raised profiles.

A very suitable material for the carrier is a three-dimensionally contoured thermoforming film. The desired relief structure is formed on this type of film by means of a thermoforming process and because of this, the film has a temperature during the production process that then makes it possible to laminate the structural surface onto it, with relative small energy input and without the use of additional materials, such as, for example, adhesive. The surface of the retainer panel then has a relief structure with lower and raised areas that result from the relief structure of the three-dimensionally contoured thermoforming film of the carrier. This is a cost-effective way of producing the retainer panel with the desired relief structure.

As described above, the structural surface of the retainer panel and the heating tubes together provide the two components of a fastener that initially releasably holds the heating tubes in place on the panel. Once the heating tubes have been laid out in the desired grid pattern on the retainer panels, it may be desirable to unreleasably fix them in place. A grout compound may be applied over the heating tube on the retainer panel, so that the heating tube is then fixed in place once the grout compound hardens. A plurality of through-holes may be provided on the retainer panel, so that the retainer panel along with the heating tube is ultimately fixed in place after the grout compound has hardened.

It is often desirable, that the retainer panel be as flat or thin as possible. The retainer panel according to the invention may have an overall height of at most 10 mm. This retainer panel is relatively thin, yet it is still suitable for accommodating heating tubes of different diameters. The flat construction of the retainer panel also simplifies the production of the carrier, because the thermoforming film only has to be stretched slightly to achieve the desired relief structure, and this is economically advantageous.

It is particularly possible that the retainer panel according to the invention have a height of at most 3 mm. In practical tests it was determined that a trough or channel having a depth of 1 to 2 mm between two raised areas, for example, between two ribs, significantly increases the contact surface between the two interacting components of the touch hook-and-loop fastener, i.e., the hook component on the tube and the loop component on the retainer panel. This very flat construction also provides significant economic advantages with regard to transportation, because the volume of this thinner product that is required to cover a certain surface area is much lower than the required volume for a thicker retainer panel.

The channels formed by ribs may be arranged in a quadratic grid having straight, intersecting channels, so that heating tubes may be laid out lengthwise and crosswise on the panel. The channels are ideally spaced evenly apart, and the distance of one channel to an adjacent one is preferably greater than the distance between two raised areas that form the boundaries of a channel, for example, between the two ribs that form a channel. Layout grids may be dimensioned for specific purposes. Just by way of example, the layout grid may be designed so that two ribs that form a channel are 8 to 20 mm apart and two parallel channels formed by ribs are between 4 and 10 cm apart.

The discussion above described channels bounded on both sides by ribs. In an alternative embodiment of the retainer panel according to the invention, the raised profiles may be used to create the relief structure, i.e., to create relief or deeper areas on the surface in a way that creates continuous, intersecting deeper areas or troughs between the raised profiles and that also allow the heating tubes to be laid out in lengthwise and crosswise directions. It is also possible to provide additional raised profiles on the areas between the intersecting channels formed by ribs. These raised profiles may be formed similarly to the other raised areas or differently.

Heating tubes are frequently laid out in a serpentine path on retainer panels and these raised profiles serve to guide the heating tubes along a curved path. The section of the heating tube that is curved can bump up against contours formed by these raised profiles. Let's assume that a heating tube is to be laid out to curve so as to achieve a 90-degree change in direction. The channels formed by ribs provide a straight-lined grid that does not accommodate a curved run of the heating tube. The curved section of the heating tube, however, makes contact against one or more raised profiles. The heating tube is in contact with the raised profiles not at the bottom of the tube, but rather, somewhat higher on the wall of the tube. Depending on the configuration of the raised profiles, the contact between heating tube and raised profile may be on the inside and/or outside curve. The tube is not lying within a channel in this curved section and, without the raised profiles, would normally only have a minimal contact with the retainer panel on this otherwise flat surface. But this contact of the heating tube against a raised profile increases the contact surface area, thereby improving the holding force on the heating tube in this curved section.

As previously mentioned, the layout of a plurality of retainer panels has to be done such, that the channels or deeper areas of adjacent panels are aligned, so that the heating tube may be smoothly guided from one retainer panel to another. To this end, the retainer panels are constructed so that, when properly installed, they cannot slip relative each other. To achieve this, an overlap strip is provided on at least one edge of the retainer panel according to the invention. This overlap strip extends out from the underside of the retainer panel, i.e., extends out to the side, beyond the edge of the retainer panel, and may be adhesively affixed with a second retainer panel of the same type.

Retainer panels that are adhesive simplifies the installation of a plurality of retainer panels. This makes it possible to adhesively affix two retainer panels of the same type to each other in the overlap area. For example, the overlap strip may be adhesive, so that a second retainer panel may be placed on the adhesive overlap strip. Alternatively, the underside of the retainer panel may be adhesive. This makes it possible to adhesively affix the retainer panel in proper alignment next to an adjacent retainer panel. It may also be advantageous, that, even with an overlap strip, the underside of the retainer panel is adhesive in an area beyond the area of the overlap strip, so that the retainer panel, when it is placed on a substrate, is adhesively fixed in position. Adhesively joining retainer panels in this way significantly simplifies the subsequent laying of the heating tubes, because no additional elements are required, such as, for example, rigid carrier panels, etc., on which the retainer panel is affixed. As a result, the structural height for the panel heating system may be kept as low as possible. Also, adhesively installing these retainer panels simplifies a possible de-installation of the panel heating system later, for example, when renovating rooms that were not originally intended to have panel heating systems installed.

Knitted fabric, loops, or mushroom-shaped fastener elements may be used to form the structural surface of the retainer panel that is referred to as the fleece or velour component of a touch hook-and-loop fastener. For example, the structural surface may be a fleece textile that has a plurality of loops. Using the fleece component to form the structural surface has several advantages. It enables a very flat construct of the retainer panel, it is a cost-effective way to produce the retainer panel, and it also provides sufficiently strong hold forces to securely fasten the tubes to the panel, whereby the tubes form the second component of a fastener, i.e., the hook component of the touch hook-and-loop fastener.

Excess material for the structural surface may be affixed to the carrier, so that the structural surface forms waves on the top of the carrier. In this way, the structural surface itself creates a macroscopically three-dimensional construction of the retainer panel that goes beyond the microscopic roughness that the material of the structural surface has. The three-dimensional structure of the carrier, i.e., the thermoforming film, may be kept correspondingly flat or thin, yet the combination of the carrier and the structural surface still provide a sufficiently large contact area between the heating tube and the structural surface to ensure a secure fastening of the tube to the retainer panel. Due to this flatness, i.e., very low thickness, of the carrier, the thermoforming film does not have to be deformed very much. Deforming the thermoforming film to a lesser degree to achieve a sufficient relief structure also means that the thermoforming film in the area of the three-dimensional deformation is also stretched or thinned to a lesser degree. As a result, a “weaker” thermoforming film may be used and still provide the same stability, for example, the same resistance to pressure, that a stronger material provides. For example, a film made of a less expensive material or a material that is thinner than may be used for a retainer panel on which the structural surface is wavy or crimped, than would be required for a retainer panel on which the structural surface lies smoothly across the surface of the carrier.

With this wavy construction of the structural surface, the structural surface may need to be affixed to the carrier only in the valleys, i.e., in the lower sections of the wavy material. The remaining peak, i.e., higher, areas of the wavy structural surface remain unfixed to the carrier and are, thus, freely movable, so that they are able to deform and thereby optimally conform to the tubular circumference of a tube placed on the retainer panel.

For example, the structural surface that is delivered as a semi-finished product, for example, as loop goods, may be pressed with a roller onto the heated carrier, so that the material of the structural surface partially penetrates the surface of the carrier and, after the carrier is cooled, forms a firm connection between the structural surface and the carrier. By using a roller with a profile, for example, a ribbed roller, only such areas of the structural surface are bonded to the carrier that make contact with the outwardly protruding sections of the profiled roller. Alternatively, if the structural surface is constructed as an essentially two-dimensional textile, different amounts of tension may be applied to the threads when manufacturing the textile, so that a crimped or wavy three-dimensional structure is automatically created in the textile.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a top plan view of a first embodiment of a retainer panel.

FIG. 2 illustrates a second embodiment of the retainer panel, with a portion of the structural surface removed to show the underlying carrier.

FIG. 3 illustrates a third embodiment of the retainer panel, with a portion of the structural surface removed to show the underlying carrier.

FIG. 4 is a vertical cross-sectional cut through a section of the retainer panel according to the invention.

FIG. 5 illustrates in a pulled-apart view of a section of a carrier and the structural surface, whereby two embodiments of the structural surface are shown, one above the other.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

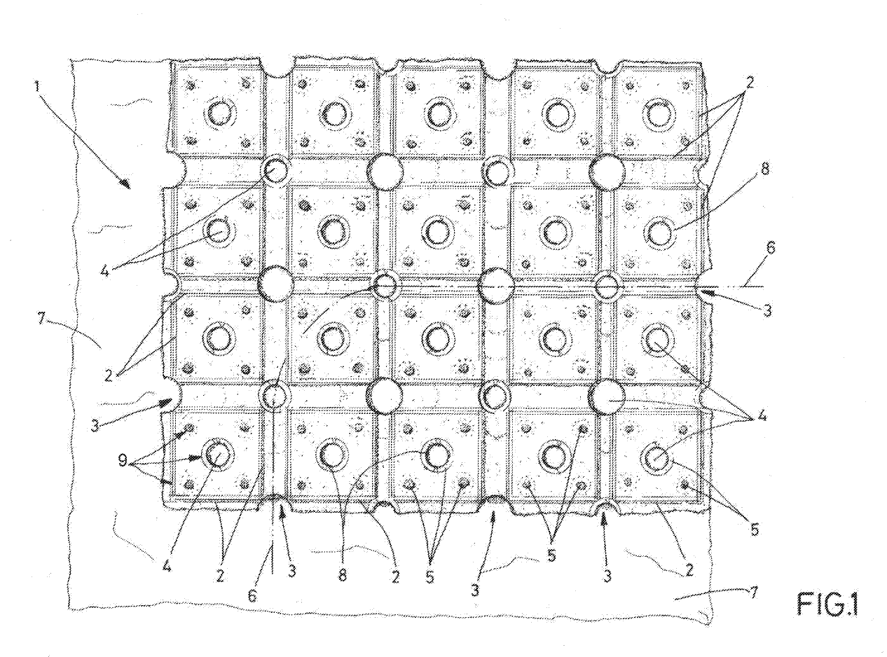

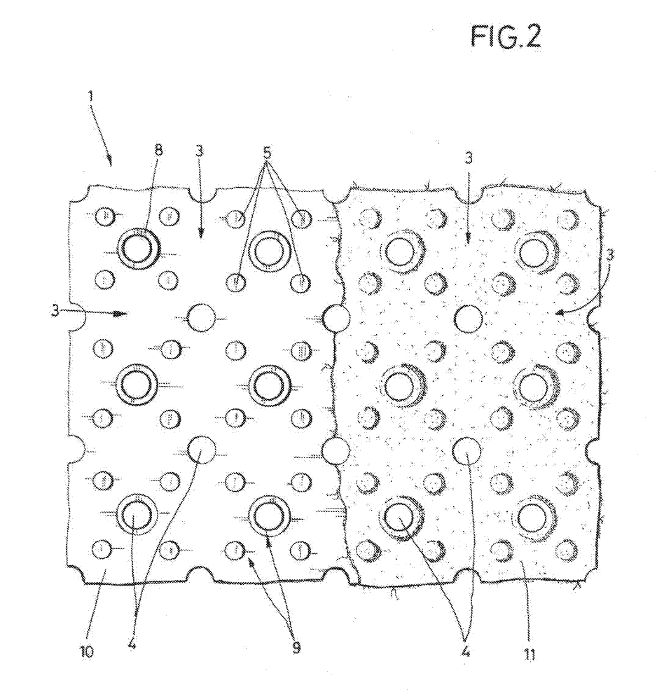

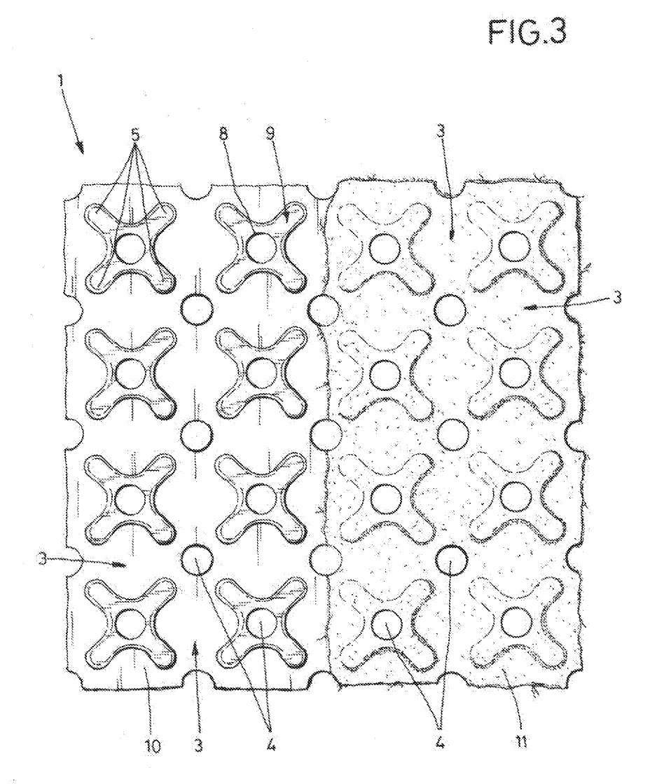

FIGS. 1 to 4 illustrate various embodiments of a retainer panel 1 according to the invention that comprises a carrier 10 and a structural surface 11. FIG. 1 is a top plan view of a first embodiment and, thus, the carrier 10 is not visible. FIGS. 2 and 3 illustrate second and third embodiments of the retainer panel 1. In these figures, the structural surface 11 is shown on only a portion of the retainer panel 1, so that the carrier 10 with its relief structure is also visible.

The carrier 10 is a plastic film and the structural surface 11 is a velour-like fleece component or a loop component of a touch hook-and-loop fastener. The hook component of the touch hook-and-loop fastener is provided on an outer surface of a heating tube 6 that is to be placed on the retainer panel 1. The structural surface 11 is directly laminated onto an upper surface of the carrier 10, completely covering it.

In the embodiment shown in FIG. 1, the carrier 10 is a thermoforming film having a three-dimensional profile that creates a relief structure on the upper surface of the carrier. Ribs 2 are provided on the carrier 10 in lengthwise and crosswise directions, thereby creating a rectangular grid, and, particularly in this case, a grid of squares. Any two parallel adjacent ribs 2 create a channel 3 between them, in which a heating tube 6, represented only schematically with a dashed line, may be placed. The channels 3 are evenly spaced and intersect each other at 90 degree angles. In the embodiment shown, the channels 3 have a depth of 1 to 2 mm.

A plurality of through-holes 4 are provided on the retainer panel 1. In the embodiment shown in FIG. 1, a central through-hole 4 is provided in the middle of each of the squares formed by the ribs 2, as well as at each intersection of the channels 3. These through-holes 4 may differ in size.

Referring to FIG. 1, the relief structure is defined by the channels 10 and a plurality of other raised areas 9. These raised areas 9 may have different forms, such as raised profiles 5 in the form of nipples or nubs that are placed a distance from the through-hole 4, closer to the corners of each square, or other raised profiles 8 that encircle the edge of the central through-hole 4 in the squares.

The heating tube 6 in FIG. 1 is shown having a curved run on the retainer panel 1. A first section of the tube 6 runs in a channel 3 that extends in what is here referred to as a lengthwise direction, a second section runs in a channel 3 in the crosswise direction, with a curved section 6A therebetween. The raised profiles 5 and 8 create trough-like or channel-like areas, so that the curved section 6A that runs between the raised profiles 5 and 8 bumps up against one or more of these raised profiles. The hook component of the touch hook-and-loop fastener that is on the outside of the heating tube 6 thus comes into contact with side portions of the raised profiles 5 and 8, thereby providing a touch hook-and-loop fastener effect at these places. This relief structure that accommodates a curved run of the heating tube 6 effectively increases the contact area between the retainer panel 1 and the curved section 6A of the heating tube 6 that lies outside of the channels 3.

FIG. 1 shows an overlap strip 7 on two sides of the retainer panel 1, namely, along one width side and one length side. An adhesive coating is applied to the underside of the retainer panel 1. This coating may be applied to the complete surface or in a grid pattern made of lines or dots, so that, in any case, the retainer panel 1 may be affixed to a substrate, as well as to the overlap strip 7 of an adjacent retainer panel 1. In this case, the overlap strips 7 are provided on the underside of the retainer panel 1.

Alternatively, the overlap strip 7 may be provided on the upper side of the retainer panel 1. For example, it may be formed by the structural surface 3, i.e., by the textile element, the so-called fleece component that forms the loops of the touch hook-and-loop fastener. The structural surface 3 extends beyond the two sides of the carrier 10, i.e., the thermoforming film, by being cut to be appropriately large, as shown in FIG. 1. The underside of the overlap strip 7 is constructed such, that it may be connected to an adjacent retainer panel 1. To this end, the underside of the overlap strip 7 is provided, for example, with a strip of the hook component of the touch hook-and-loop fastener, so that the overlap strip 7 may be pressed from above onto the structural surface 3 of an adjacent retainer panel 1, fastening the two panels 1 together. Or the underside of the overlap strip 7 that is placed on top of the other strip may be coated with an adhesive, for the same purpose.

FIG. 2 illustrates a second embodiment of the retainer panel 1 that comprises the carrier 10 and the structural surface 11 discussed with reference to FIG. 1, but with a different relief structure. Instead of the channels 3 formed by ribs 2, the relief structure creates the channels 3 exclusively by the raised profiles 5 and 8. Similarly to the embodiment shown in FIG. 1, four smaller raised profiles 5 are arranged in a quadratic pattern around each central through-hole 4 with its raised circular profile 8. This configuration of five raised profiles 5 and 8 is referred to as a nipple group. The left half of FIG. 2 shows the carrier 10, and the right half the structural surface 11 that covers the carrier 10.

The four smaller raised profiles 5 of the nipple group in the embodiment shown in FIG. 2 may be spaced a greater distance from the central raised profile 8 than is shown in FIG. 1. Or the quadratic grid pattern in which the individual nipple groups are arranged relative each other may be smaller than is shown in the embodiment of FIG. 1. In any case, the result is that the channels 3 run in straight lines and intersect each other between the nipple groups, the channels 3 having a similar width as the channels 3 shown in the embodiment of FIG. 1.

FIG. 3 illustrates an embodiment in which the four smaller raised profiles 5, which are individually formed in the embodiments shown in FIGS. 1 and 2 and mark the four corners of a square, are connected to each other to form a cross-or X-shaped raised area 9. These cross- or X-shaped raised areas 9 are also arranged in a square grid, so that, with this embodiment, too, channels 3 are formed between the raised areas 9, these channels also running in straight lines and intersecting each other. Similarly to FIG. 2, the left half of FIG. 3 shows the carrier 10, and the right half the structural surface 11 that covers the carrier 10.

The through-holes 4 in the embodiments shown in FIGS. 2 and 3 may be provided, as shown in the embodiment of FIG. 1, as central through-holes 4, always in the center of a nipple group or of a cross-shaped raised area 9, as well as through-holes 4 that are placed at intersections of the channels 3. Thus, the X-shaped raised areas 9 in the embodiment shown in FIG. 3 connect not only the four smaller raised profiles 5, but they also integrally form the raised profiles 8 around the central through-holes 4, which are constructed as separate rings in the embodiments shown in FIGS. 1 and 2.

FIG. 4 illustrates a vertical cross-section through the retainer panel 1, whereby the cut runs through two raised areas 9, as well as through the intersection of two channels 3 and, thus, through the corresponding through-holes 4. The retainer panel 1 in this area of the vertical cross-section consists of just two elements: the carrier 10 and the structural surface 11. The three-dimensionally shaped thermoforming film that forms the carrier 10 has a relief structure that has a lower or relief area and a raised area. The structural surface 11 that is laminated to the carrier 10 is a fleece textile that serves as the fleece component of a touch hook-and-loop fastener and, accordingly, is a textile with many loops. The structural surface 11 is pressed into the heated material of the carrier 10 as a way of directly laminating the surface 11 to the carrier 10, thereby creating a firm bond between the two elements 10 and 11, without the use of additional materials, such as adhesive.

During the lamination process, the structural surface 11 is pressed onto the raised areas 9 of the relief structure of the carrier 10. The fabric or material of the structural surface 11 is thus suspended freely between the raised areas 9, possibly without making contact with the carrier 10. In order to simplify the stamping process and ensure a precise stamping result when stamping out the through-holes 4 at the intersections of channels 3, a highly profiled pressure pad may be used, for example, a profiled roller, which is able to press the structural surface 11 even into these deeper lying intersecting areas on the carrier 10, so that the structural surface 11 is laminated onto the carrier 10 even in these deeper areas.

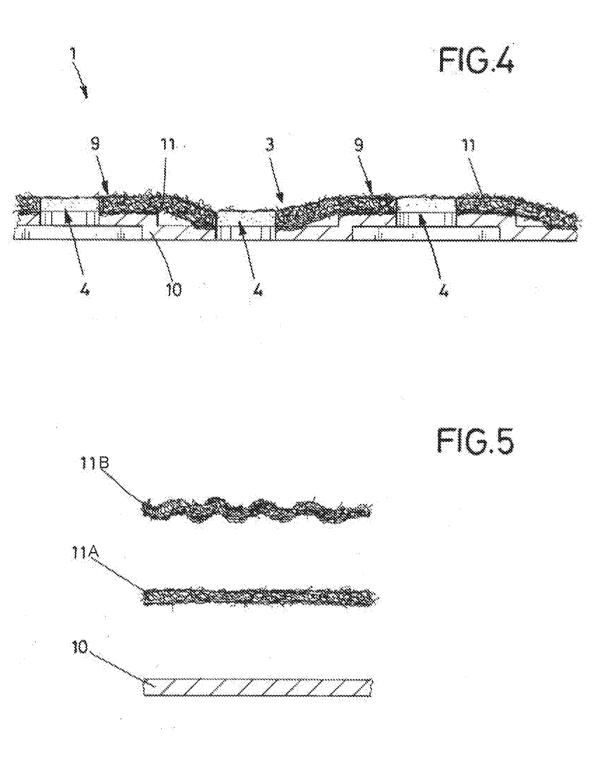

FIG. 5 illustrates an exploded cross-sectional view of the carrier 10, showing two variants of the structural surface 11 that may be laminated to the carrier 10 to create the retainer panel 1 according to the invention. The carrier 10 is shown here as a flat element, without a relief structure, because the view is only of a small section of the carrier 10 at a place where the carrier is flat.

A first variant of a structural surface 11A is shown in the middle of FIG. 5, above the carrier 10. Seen microscopically, the texture of the material of the fleece component of the touch hook-and-loop fastener is rough, because it has many loops. Macroscopically, however, the structural surface 11A is shown as a flat element.

By contrast, a second variant of a structural surface 11B shown in the upper portion of FIG. 5 is not only microscopically rough due to the texture of the material of the fleece potion, but it is also macroscopically rough or uneven. When producing this fleece component, different tensions are applied to the threads, producing a three-dimensional, relief-like, crimped or wave-like structure. Such structures are also referred to as “crushed,” i.e., crumpled or creased. Compared to the flat or smooth construction of the structural surface 11A, an excessive amount of the material of the structural surface 11B is applied to the carrier 10 to obtain the relief-like structural surface 11B.

Regardless of the relief structure of the carrier 10, the structural surface 11 itself has a three-dimensionality or depth to it, so that it imparts a particularly strong hold on the heating tube 6 that is pressed onto the retainer panel 1, even there, where the carrier 10 runs smoothly, i.e., does not exhibit a relief structure.

A similar macroscopically rough structure of the structural surface 11 on the carrier 10 may be achieved, even if the structural surface 11 is initially not macroscopically rough, i.e., is not produced, for example, as a crimped textile 11B. If, for example, the the structural surface 11 is the macroscopically flat structural surface 11A, then a profiled roller may be used in the lamination process to press this flat structural surface 11A onto the carrier 10. The use of a profiled roller results in a crimped or wave-like shape that corresponds to that of the structural surface 11B.

Accordingly, the relief-like structural surfaces 11A/11B may be used on a carrier 10 that has only a low surface profile, yet nevertheless ensure a significant holding strength for the heating tube 6.

The manufacture of the retainer panel 1 according to the invention is cost-effective, because the low three-dimensionality of the thermoformed carrier 10 contributes to a reduction in production costs. Also, the circular raised profiles 8 that are provided around the central through-holes 4 are simple to create, by providing a raised profile initially having a large, circular surface area and then stamping the appropriate circular raised profiles 8 from it, in order to create the central through-hole 4 with the raised profile 8. The fleece component of the touch hook-and-loop fastener is laminated as the structural surface 11 onto the carrier 10, namely, onto the thermoforming film. The stamping process does not cause a problem, because the structural surface 11 and carrier 10 are firmly bonded together in the lamination process. As a result, the velour-like fleece material cannot pull or yield and thereby avoid being stamped along with the carrier material.

What is claimed is:

1. A retainer panel in a panel heating system, the retainer panel comprising:
a carrier having a top surface that has a relief structure with relief areas and raised areas; and
a structural surface that is partially pressed into the top surface of the carrier in a direct lamination process;
wherein the relief surface of the carrier is dimensioned to receive a heating tube between raised areas; and
wherein the structural surface serves to fix the heating tube in place on the retainer panel.

2. The retainer panel of of claim 1, wherein the relief structure is constructed as a type of layout grid.

3. The retainer panel of claim 1, wherein the carrier is a three-dimensionally formed thermoforming film.

4. The retainer panel of claim 1, wherein a plurality of through-holes are provided on the carrier and structural surface.

5. The retainer panel of claim 1, wherein the retainer panel has a height of at most 10 mm.

6. The retainer panel of claim 5, wherein the retainer panel has a height of at most 3 mm.

7. The retainer panel of claim 1, wherein at least a portion of the raised areas on the relief structure includes pairs of parallel ribs, each pair creating a channel that is dimensioned to receive a portion of a circumference of the heating tube.

8. The retainer panel of claim 7, wherein the relief structure includes a plurality of channels that intersect each other.

9. The retainer panel of claim 8, wherein the two ribs that form the channel are spaced a first distance apart and two parallel channels are spaced a second distance apart that is greater than the first distance.

10. The retainer panel of claim 7, wherein the channels are arranged in a quadratic grid.

11. The retainer panel of claim 7, wherein a plurality of raised profiles are provided in areas between the channels and are spaced apart from each other such, that any two adjacent raised profiles provide a free space between them that is dimensioned to receiving a curved section of the heating tube.

12. The retainer panel of claim 1, wherein the retainer panel has a four edges and wherein an overlap strip is provided under the carrier on at least one of the four edges and that is connectable with an adjacent retainer panel.

13. The retainer panel of claim 12, wherein the retainer panel is adhesive, so as to allow an adhesive bond with the overlap strip of an adjacent retainer panel.

14. The retainer panel of claim 12, wherein an underside of the retainer panel is adhesive.

15. The retainer panel of claim 14, wherein the underside of the retainer panel is adhesive on the overlap strip and beyond the overlap strip.

16. The retainer panel of claim 1, wherein a touch hook-and-loop fastener serves to fix the heating tube, wherein the structural surface is a fleece component of the touch hook-and-loop fastener, and wherein a hook component of the touch hook-and-loop fastener is provided on the heating tube.

17. The retainer panel of claim 1, wherein the structural surface is affixed to the carrier with an excess amount of material, such that the structural surface lies on the carrier in a wave-like form.

18. The retainer panel of claim 17, wherein the wave-like form has peaks and valleys and the structural surface is affixed to the carrier only at the valleys.
